(19) United States
(12) Patent Application Publication
(10) Pub. No.: US 2025/0073740 A1
(43) Pub. Date: Mar. 6, 2025

(54) SEMI-AUTONOMOUS RAIL GLUING SYSTEM

(71) Applicants: Gregory Scott Fowler, Alpharetta, GA (US); Jeff Kaetterhenry, Sugar Hill, GA (US)

(72) Inventors: Gregory Scott Fowler, Alpharetta, GA (US); Jeff Kaetterhenry, Sugar Hill, GA (US)

(21) Appl. No.: 18/456,938

(22) Filed: Aug. 28, 2023

(51) Int. Cl. B05C 5/02; B05C 13/02

(52) U.S. Cl. CPC B05C 5/0216; B05C 13/02

(57) ABSTRACT

A semi-autonomous spray applicator system for a plurality of elongated members. The semi-autonomous spray applicator system provides a plurality of spaced apart pockets, wherein each pocket establishes a centerline and proximal endpoint for the pocketed elongated member. A rail detection system of the semi-autonomous spray applicator system is configured to sense the opposing distal endpoint of each elongated member as the longitudinal length of each member may vary pocket to pocket. A traversing applicator head operatively associated with the system applies adhesive spray to a longitudinal edge and a distal end of sensed, pocketed elongated members, wherein the application of spray is selectively controlled by way of a user interface.

### BACKGROUND OF THE INVENTION

The present invention relates to adhesive application systems and more particularly, to a semi-autonomous rail gluing system for applying adhesive to the edges of mattress rails, facilitating the assembly of a mattress with the mattress rails.

There are many types of mattresses. One of if not the most common mattress is the innerspring mattress that is essentially an innerspring unit comprising a wire frame paired with a few hundred springs. The innerspring unit is encased in s soft material, such as a foam layer as well as one or more upholstery layers. The form layer includes at least a base layer supported by peripheral mattress rails of foam that surround the innerspring unit.

A lion share of today's production systems for adhering the mattress rails to the top comfort layer are either manual or fully automated gluing systems. Each system has operational disadvantages because recruiting, training, and maintaining operators for a production factory is very challenging in today's job market generally, and particularly in the field of industrial manufacturing.

Any system for gluing mattress rails requires application of adhesive to the mattress rails at the right location, with the right volume, and for the minimum time needed for meeting the bonding requirements and production output. Specifically, the amount of adhesive and the time to apply the adhesive to the mattress rails prior to their adherence to the top comfort layer is critical to the bond of the resulting joints.

The manual systems utilize skilled labor for the gluing portion of the process. Production balancing requires at least two operators to maintain capacity to manually glue and assemble. Intensive operator involvement in the application of the adhesive translates to extremely variable results due to human error, creating waste and risking the quality of construction. Manual systems also require significant time to train operators, who take weeks to become efficient in production. Furthermore, the glue is very difficult to control using handheld spray guns, which results in a dirty production area, the cleanup of which consumes valuable production time. The operators must spend significant time applying the adhesives properly then take additional time to assemble properly. The time to train and adapt the manual dexterity to spray properly is a disadvantage considering today's high workforce turnover rate, making it very difficult to maintain production.

The fully automated systems require skilled technicians to set up and maintain the interrelated equipment, and these types of technicians are even more difficult to find in today's job market for industrial manufacturing. The existing fully automated solutions are also very large in size resulting in large amounts of space to properly operate. In addition to being large, fully automated systems are operationally complex requiring higher level technical skills to set up and maintain. Automated systems maintenance and adjustment for variations in raw materials requires also demands highly skilled technicians that are extremely difficult to obtain. Furthermore, foam raw materials have considerable variation requiring routine adjustments to the variables of the automated equipment for it to work properly, which puts more demands on the operators of fully-automated systems.

A need exists for semi-automated equipment that simplifies and controls the process of spray-on application along a longitudinal edge and end of a rail, thereby enabling the operator to focus on other aspects of the production sequence, such as material loading and the assembly of the resulting glued rails.

### SUMMARY OF THE INVENTION

A semi-autonomous mattress rail gluing system is provided to reduce the dependencies of operator's skill and technicians' knowledge requirements. The unique equipment design orients the product to reduce the footprint requirements of a product workspace. The present invention uses precision machine controls, motion, and apparatus to assure the proper placement, time, and volume of the adhesive applied to the rail. This allows the operator to focus on just-in-time assembly of the mattress unit through being enabled to assemble a first, already-glued rail while the system is in the process of gluing a second rail, thereby turning a two-person job into a one-person task.

The semi-autonomous equipment design uses a quarter of the space compared to the fully automated systems due to the unique vertically tilted orientation of the elongated member being processed during the adhesive application process. The placement of adhesive is controlled for volume, position, and time as opposed to a human operator using a handheld spray gun. The glue consumption can be precisely controlled on any given length of the mattress rail. The labor requirements are cut in half to complete the production task because of all these advantages.

In one embodiment, the present invention glues the opposite side of the rail making it very simple for the operator to grab and assemble. Furthermore, the present invention enables the foam rails to be held stationary while the apparatus moves, which is distinguishable from the prior art which moves the rail component. Thus, the present invention enables the use of a robot in this application. Overall, the vertical orientation of the rails being applied with adhesive is key to the footprint the production floor making this equipment fit into the factories production systems due to such a small size available.

In one aspect of the present invention, a method of improving a mattress rail assembly, the method comprises successively applying a sprayable product (such as a spray adhesive) to a plurality of mattress rails spaced apart, respectively, in a plurality of pockets, wherein each pocket and thus each longitudinal axis of the mattress rail is oriented in a vertical orientation.

In some embodiments, the vertical orientation is at a tilt angle offset approximately six to ten degrees relative to a plumb vertical line.

In another aspect of the present invention, the method further includes wherein the plurality of pockets share a horizontal datum (orthogonal to the vertical orientation); configuring an applicator head to apply the spray adhesive only when sensing a length of each mattress rail in a respective pocket, wherein the applicator head is oriented to apply the spray adhesive only in the vertical orientation, and wherein the applicator head is oriented at an angle of incidence relative to a longitudinal axis of each mattress rail so that a distal end of the mattress rail has spray adhesive applied thereto.

In yet another aspect of the present invention, semi-autonomous spray applicator for a plurality of members, the semi-autonomous spray applicator includes the following: a plurality of pockets evenly spaced apart along a frame so that the plurality of pockets share a horizontal datum; a rail detection component configured to sense a member occupying each pocket; and an applicator head operatively associated to move along the frame, wherein the applicator head is configured to spray vertically along a centerline of each pocket only when sensing an occupying member, wherein the applicator head is oriented at an angle of incidence relative to said centerline so that a distal end of each member has spray adhesive applied thereto.

These and other features, aspects and advantages of the present invention will become better understood with reference to the following drawings, description, and claims.

### BRIEF DESCRIPTION OF THE DRAWINGS

FIG. 1 is a top perspective view of an exemplary embodiment of the present invention, shown in use.

FIG. 2 is a schematic plan view of an exemplary embodiment of an overall workspace area 40 of the present invention, illustrating how one operator in conjunction with the semi-autonomous rail gluing apparatus 10 can complete the task of assembling mattress rail assemblies 42 in the confined workspace area 40. This contrast with and is advantageous over (a) prior art manual systems for gluing mattress rails that require two operators, and (b) prior art fully automated systems for gluing mattress rails which require more space, more technical expertise for maintenance, and more startup costs.

FIG. 3A is a flow chart 50 of an exemplary embodiment of the present invention.

FIG. 3B is continuation of the flowchart 50 of FIG. 3A.

FIG. 4 is a top perspective view of an exemplary embodiment of a mattress rail assembly 42, illustrating a “pixie wheel configuration” of assemblage, wherein only one end of each rail (say, 42A) abuts a side surface of an adjacent rail (here, 42B). Accordingly, only the abutting end needs adhesive applied thereto. The mattress rail assembly 42 also illustrates the mechanical communication of the mattress base 42C to only one longitudinal edge of each rail 42A and 42B; accordingly, only one longitudinal edge of each rail 42A/42B needs adhesive applied thereto. (The pixie wheel configuration contrasts with a railroad configuration, which would require adhesive applied to both ends for half the rails and no adhesive applied to either end of the other half of the rails.)

FIG. 5 is an elevation view of an exemplary embodiment of the present invention, illustrating showing the angle of incidence of the applicator head relative to the longitudinal axis of a target rail.

FIGS. 6A-6D are a series of schematic views of FIG. 5 shown in use as the applicator head moves relative to the stationary foam rail that the applicator applies a spray along one edge. FIG. 6A is phase 1, wherein the presence of the rail is sensed, and ‘vertical’ motion of the applicator is started simultaneously with the application of the spray. FIG. 6B is phase 2, wherein the presence of the top of rail is sensed, and an overshoot timer is initialed as the ‘vertical’ motion of the applicator continues simultaneously with the application of the spray. FIG. 6C is phase 3, illustrating the continued timed ‘vertical’ motion of the applicator continues simultaneously with the application of the spray resulting in ‘horizontal’ spray. FIG. 6D is phase 4, wherein stop timed ‘vertical’ motion continues for timed dwell.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a semi-autonomous spray applicator system for a plurality of elongated members. The semi-autonomous spray applicator system provides a plurality of spaced apart pockets, wherein each pocket establishes a centerline and proximal endpoint for the pocketed elongated member. A rail detection system of the semi-autonomous spray applicator system is configured to sense the opposing distal endpoint of each elongated member as the longitudinal length of each member may vary pocket to pocket. A traversing applicator head operatively associated with the system applies adhesive spray to a longitudinal edge and a distal end of sensed, pocketed elongated members, wherein the application of spray is selectively controlled by way of a user interface.

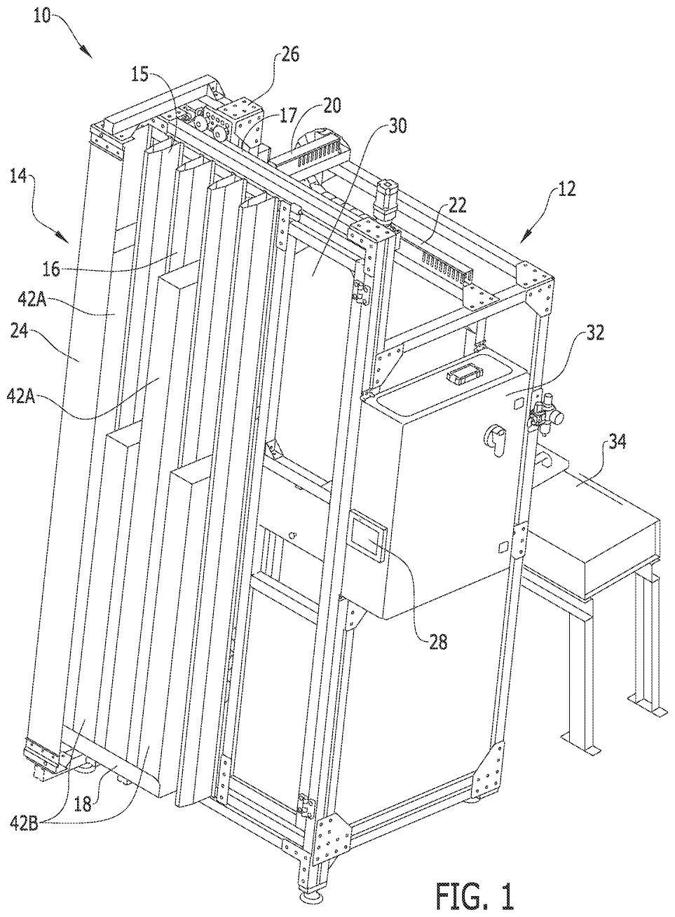

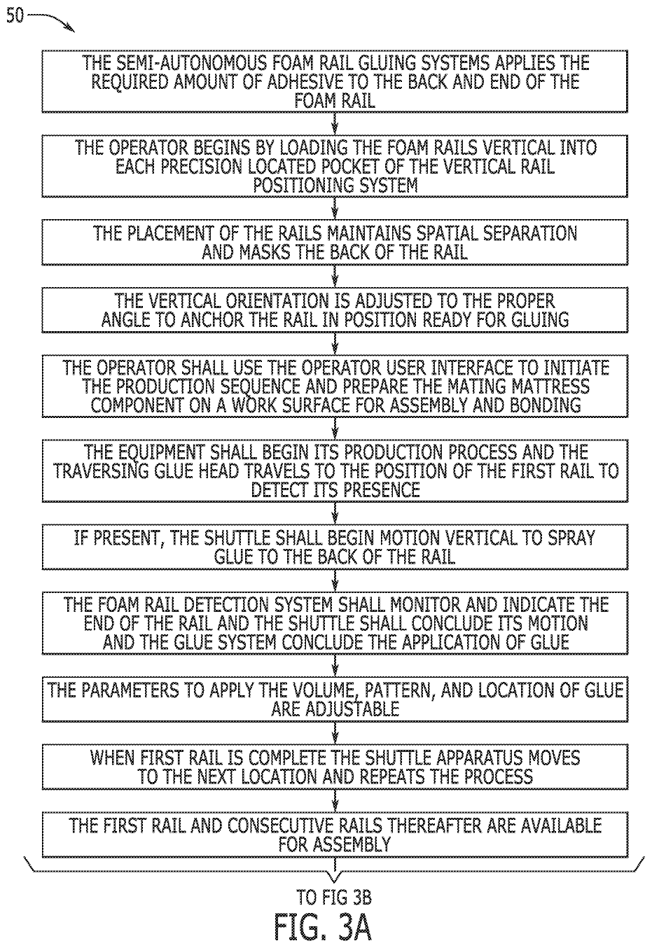

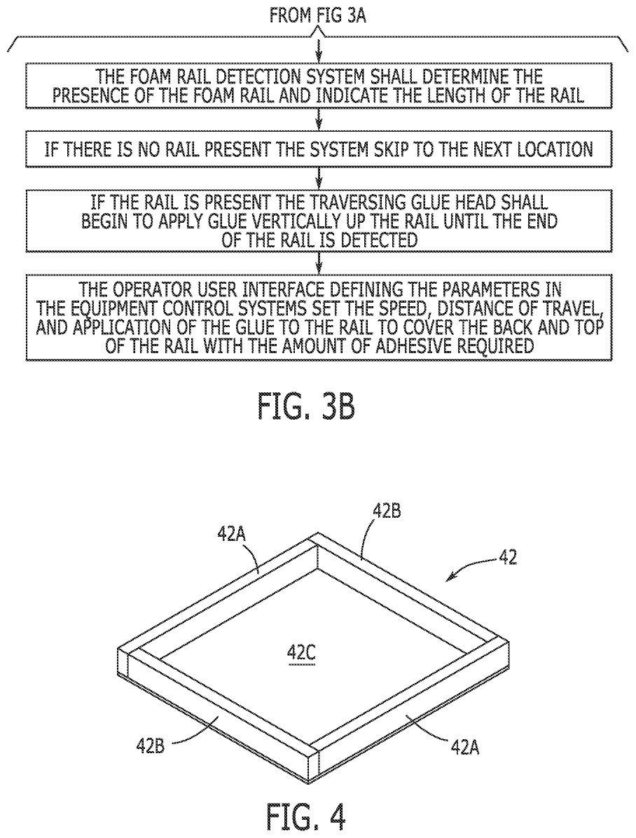

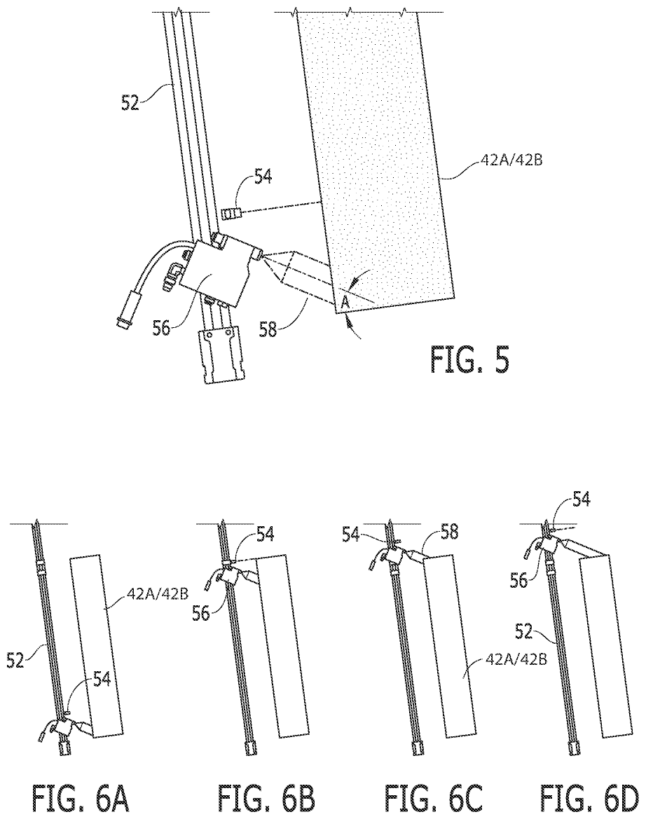

Referring to FIGS. 1 through 6D, the present invention may include a semi-autonomous rail gluing apparatus 10 adapted to selectively apply a sprayable product to a longitudinal edge and an end of an elongated member 42A/42B.

The operator 11 of apparatus 10 may use the autonomous rail gluing apparatus 10 by loading one or more rails 42A and/or 42B into a vertical rail positioning system VRSP 14. The VRSP 14 provides a plurality of spaced apart separators 16, wherein each two adjacent separators 16 define a vertically oriented pocket 15. The plurality of separators 16 maintain a precise spatial separation of each pocket 15 whereby a centerline of each rail 42A/42B aligns with a centerline of its pocket 15. Each separator 16 may operatively associate with a separator framework 17 that enables each separator 16 to be selectively fixed in place or unfixed so that they can be moved relative to an adjacent separator 16. The centerline of each pocket 15 is used by the present invention during application of the sprayable product to the rails 42A/42B slotted in pockets 15. In some embodiments, the separators 16 are evenly spaced apart a nominal distance on their centerlines.

An applicator head shuttle apparatus 26 may be in mechanical communication with framing structure so that an operatively associated traversing applicator head 56 selectively moves relative to each pocket 15. In some embodiments, a separator framework 17 provides one or more tracks that the applicator head shuttle apparatus 26 moves along in an x-axis direction. A depth framing 20 may enable the shuttle apparatus 26 to move along a z-axis. The depth frame may be supported in part by the base frame 12. The applicator head shuttle apparatus 26 may provide a vertical actuator 52 (supported along a upper end by the depth framing 20, in some embodiments) along which the applicator head 56 operatively associates to travel in a y-axis direction, as illustrated in FIGS. 6A-6D.

The selective movement of the traversing applicator head 56 may be in a parallel direction or transverse direction relative to each pocket 15. For the sake of clarity, the parallel direction is generally vertical, parallel with a y-axis—i.e., along the longitudinal axis or centerline of each pocket 15. Accordingly, the transverse direction may be movement of the traversing applicator head 56 along an x-axis (e.g., from pocket 15 to pocket 15) or a z-axis orthogonal to both the x-axis and y-axis. Movement along the z-axis enables a user to selective space the traversing applicator head 56 apart and rearward from each pocket 15.

A docking member 18 (such as a plate or other element) may define the bottom most (vertical) elevation of each pocket 15. The present invention uses this bottom most elevation or “horizontal datum” as a known position during application of adhesive by way of the traversing applicator head 56. The separator framework 17 may also support a cover deflector shield 24 and an enclosure 30.

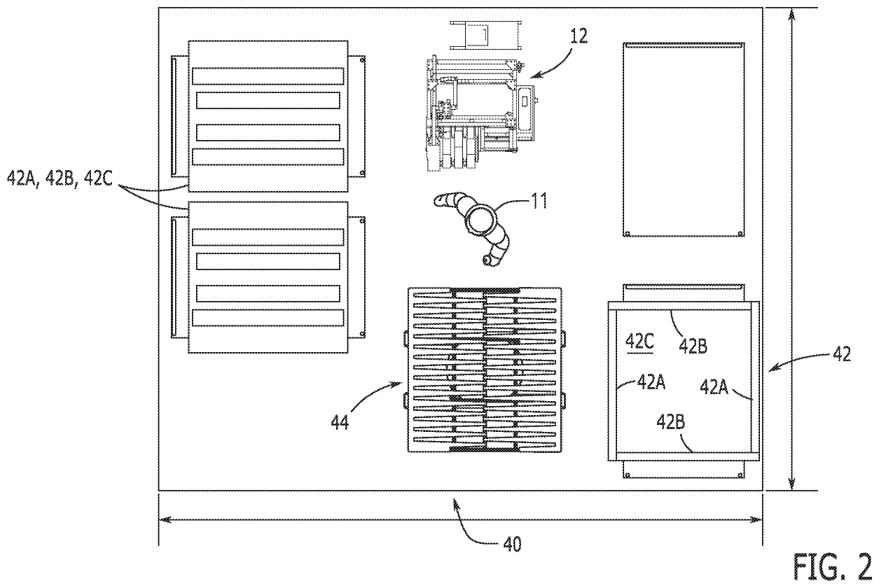

A base frame 12 may support the separator framework 17 as well as a rail detection system 22 and an equipment controller 32 with an operator user interface 28. The base frame 12 may have lean or tilt, as illustrated in FIG. 1, so that a rail 42A/42B received in a pocket 15 rests, by way of gravity, against a rear portion of each pocket 15, thereby anchoring a received rail 42A/42B in position ready for gluing. The tilt/lean may be approximately six to ten degrees relative to a supporting surface, and in certain embodiments may be provided by elevating a front side of the base frame 12 off the supporting surface (for instance, by way of feet 19) than a rear side. As a result of the tilt, the y-axis may not be true plumb line vertical (at the surface of the earth) but rather offset therefrom by the angle of the tilt or vertical tilt angle. The vertical tilt angle may range between approximately six to ten degrees. The operator 11 may use the operator user interface 28 to initiate the production process that includes the application of adhesive on one longitudinal edge and one end of each rail 42A and 42B. The production sequence also includes preparation of the mating mattress component on a work surface (e.g., an assembly table 44) for assembly and bonding of two first rails 42A and two second rails 42B to form the dixie chain configuration mattress rail assembly 42 of FIG. 4. Relatedly, FIG. 2 schematically represents an advantageous workspace area 40 relative to the prior art.

Referring to FIGS. 6A-6D, the production process involves the traversing applicator head 56 initially travelling to a starting position of the first rail whose presence is detected by the rail detection system. Accordingly, the traversing applicator head 56 is associated with the first, proximal end of the longitudinal edge of the rail (typically the lowest vertical endpoint of the rail 42A/42B), as illustrated in FIG. 6A. The rail detection system 22 is configured to detect a rail 42A/42B occupying a pocket, as well as the proximal and distal end points of the longitudinal edge of said rail 42A/42B. The rail detection system 22 may include a foam rail sensor 54 operatively associated with the vertical actuator 52 and/or applicator head 56.

Accordingly, if a rail is detected, the shuttle 26 shall begin motion in a tilted vertical direction (along the y-axis), applying a spray plume 58 of product/glue to the adjacent longitudinal edge of the rail 42A/42B. The rail detection system 22 monitors and indicates the end of the rail 42A/42B so that the shuttle 26 concludes its motion and the glues system concludes the application of product/glue in a predeterminable manner. The parameters to apply the volume, pattern, and location of glue, applied by way of a glue system 34, are selectively adjustable by way of the operator user interface 28. When the first rail is complete the shuttle 26 apparatus moves (along the x-axis) to the next detected rail and repeats the process. The first rail and consecutive rails thereafter are available for assembly.

The equipment controller 32 provides the logical processing of inputs and outputs for the detection, motion, and application control of applying the glue. The rail detection system 22 is configured to determine the presence of the rail and indicate the length of the rail through at least identification of the rail's sensed endpoints. Thus, if there is no rail present in pocket 15, the system skips to the next location/pocket 15. If the rail is present, the traversing applicator head 56 begins to apply glue vertically up the rail until the distal end of the rail is detected. The user interface 28 enables a user 11 to selectively define the parameters in the equipment controller 32—e.g., set the speed, distance of travel, and application of the glue to the rail to cover the longitudinal edge and end face of the rail with a predetermined amount of adhesive.

The motion path when the traversing applicator head 56 is applying adhesive is only in the (tilted) vertical direction (along the y-axis)—i.e., “bottom-up” application. In certain embodiments, the traversing applicator head 56 is set back approximately five inches (along the z-axis) from the rear longitudinal edge on which the adhesive is applied. The traversing applicator head 56 may be oriented downward (toward the horizontal datum) at an approximately 15-degree to 45-degree spray angle ‘A’. The spray angle ‘A’ enables spraying of a distal/upper end of a rail 32A/42B. Specifically, as the traversing applicator head 56 vertical moves upward (along the tilted y-axis) past the end point of said rear longitudinal edge, the spray plumb 58 of adhesive starts being applied to a upper end of the rail 42A/42B, as shown in FIG. 6D. Accordingly, the present invention may set, by way of the operator user interface 28, the vertical elevation at which spraying of the adhesive ceases depending on the depth (in the z-axis) of the rail 42A/42B and the inherent tilt of the apparatus 10.

Similarly, the movement of applicator head 56 is controlled, whereby the applicator head 56 can be programmed to overshoot (by selecting the parameters through the operator user interface 28) and to keep applying for a preset period even though it is not moving. In most embodiments, the applicator/applicator head 56 is moving before spraying to prevent a pool of glue formed (this pooling prevention is another advantage of the present invention as it uses less glue than the prior art manual systems.

In some embodiment, a mounting bracket (e.g., shaped rolled forms) may mount a rail into a pocket so that a centerline of the rail aligns with a centerline of the pocket 15. As a result, rails of different widths (along the x-axis) may be engaged in pockets 15 of the same widths, as the mounting brackets fill the difference between the rail width to the pocket width.

The semi-autonomous rail gluing apparatus 10 should provide a physical datum for the members/rails having glued applied thereto. The vertical rail positioning system 14 enables establishment of the datum for the pocketed rails. An option to the design is to use a manifold with multi-glue nozzle applicators to apply adhesive to all rails at once instead of traversing for one at a time. This eliminates the horizontal (x-axis) motion in the apparatus.

Additionally, the semi-autonomous rail gluing apparatus 10 may be used with any elongated member requiring the application of a sprayable product along a reasonably long surface through the methodology with adjustment to the vertical rail position system disclosed herein. Accordingly, the present invention may be used to produce foam encasements for mattresses, or other foam assemblies in similar form for the furniture goods industry.

The inventive concept embodied in the present invention is applying sprayable adhesive to members in a vertical orientation, using center-line indexing, wherein the application process is “intuitive” through a logic rule where the application of sprayable adhesive requires a sensed member-thus the present invention does not have to programmed or ‘determine’ a length because once a ‘length’ goes undetected the application ceases after a predetermined time. Furthermore, gluing the opposite side of the rail (the rear side of the rail relative to the operator) makes it very simple for the operator to grab and assemble. Moreover, the foam rails being stationary and then the applicator moving is key as most other technologies move the components; thus, the inventive concept embodies the use of a robotic application/applicator vs the actuation system. Overall, the vertical orientation is key to the production footprint relative to the production floor making this equipment fit into the factories production systems due to such a small size.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A method of applying a sprayable product to a plurality of elongated members, the method comprises sequentially applying the spray product to a plurality of elongated members disposed in a vertical orientation, wherein each elongated member occupies, respectively, a plurality of a plurality of pockets.

2. The method of claim 1, wherein the plurality of pockets shares a horizontal datum.

3. The method of claim 1, further comprising configuring an applicator head to apply the sprayable product, for each pocket, only when sensing a length of the elongated member in the pocket.

4. The method of claim 1, wherein the applicator head is configured to move along an application path so as to apply the sprayable product only along said vertical orientation.

5. The method of claim 1, wherein the applicator head is configured to apply the sprayable product at an adjustable rate of application to control a volume of the sprayable product applied to the rail.

6. The method of claim 1, wherein the vertical orientation is defined by a tilt angle of between six to ten degrees relative to a plumb line.

7. The method of claim 6, wherein the applicator head is oriented at an angle of incidence relative to the tilt angle so that a distal end of the elongated member has sprayable product applied thereto as the applicator head finishes the application path.

8. The method of claim 2, wherein the horizontal datum is orthogonal to the tilt angle.

9. The method of claim 1, wherein the sprayable product is an adhesive.

10. The method of claim 2, wherein the elongated member is a rectangular cuboid.

11. A semi-autonomous spray applicator for a plurality of members, the semi-autonomous spray applicator comprises:
a plurality of pockets evenly spaced apart along a frame so that the plurality of pockets shares a horizontal datum;
a rail detection component configured to sense a member occupying each pocket; and
an applicator head operatively associated to move along the frame, wherein the applicator head is configured to spray vertically along a centerline of each pocket only when sensing the occupying member.

12. The semi-autonomous spray applicator of claim 11, wherein the applicator head is oriented at an angle of incidence relative to said centerline so that a distal end of each member has spray adhesive applied thereto for a controllable period.
